(19) United States
(12) Patent Application Publication
(10) Pub. No.: US 2026/0312326 A1
(43) Pub. Date: Oct. 8, 2026

(54) FIRST ELECTRICAL CONNECTOR, SECOND ELECTRICAL CONNECTOR AND CONNECTOR ASSEMBLY

(71) Applicant: Molex, LLC, Lisle, IL (US)

(72) Inventors: Chu-Jun Liang, Xian (CN); Xu Yang, Chengdu City (CN); Min Chen, Zhuhai (CN)

(21) Appl. No.: 19/634,157

(22) Filed: Mar. 31, 2026

(30) Foreign Application Priority Data
Apr. 2, 2025 (CN) 202510409828.0

(51) Int. Cl. H01R 13/424; H01R 13/502

(52) U.S. Cl. CPC H01R 13/424; H01R 13/502

(57) ABSTRACT

Connector assemblies are described. An example electrical connector includes an insulative housing, a plurality of conductive terminals, and a terminal stabilizer. A mating side of the insulative housing forms a mating cavity. The plurality of conductive terminals are mounted in the insulative housing. Mating portions of the plurality of conductive terminals protrude into the first mating cavity. The terminal stabilizer comprises a plurality of terminal exposing holes to correspondingly expose the mating portions of the plurality of conductive terminals. A mating side of the terminal stabilizer is provided with a pair of elastic latching structures with an inserting space therebetween. Each elastic latching structure includes at least one latching claw, which extends away from a mating direction, to latch on the insulative housing, so that the terminal stabilizer and the plurality of first conductive terminals are retained in a complete mating position.

### TECHNICAL FIELD

The present disclosure relates to an electrical connection device and particularly relates to electrical connectors in which mating of terminals is smooth and the terminals are not easy to be bent.

### BACKGROUND

United States patent US10193276B1 discloses a connector housing assembly, the connector housing assembly includes a connector housing, a terminal position assurance member and a male blade stabilizer. The connector housing has a pair of side walls, a front wall, a rear wall, and a bottom wall, the bottom wall defines a connector cavity, the connector cavity is capable of receiving an electric connector and has a plurality of terminal cavities; the terminal position assurance member has a top surface, a bottom surface, a plurality of first terminal slots, and a pair of walls, the terminal position assurance member is positioned in the connector cavity; the male blade stabilizer has a top surface, a bottom surface, a plurality of second terminal slots, and an aperture, the aperture has a pair of inner edges defining side surfaces of the aperture, wherein each of the pair of inner edges is offset from the other, the male blade stabilizer is positioned in the connector cavity over the terminal position assurance member, wherein a width of each of the pair of walls of the terminal position assurance member is the same as a length of the corresponding one of the pair of inner edges of the aperture and the male blade stabilizer abuts the corresponding inner edges of the aperture when the male blade stabilizer is positioned over the terminal position assurance member.

The United States patent is intended to ensure that the terminal cavities of the connector housing and the terminal slots of the terminal position assurance member and the terminal slots of the male blade stabilizer are aligned with each other to allow terminals to be positioned therein and prevent the terminals from being bent. However, constituent components of the connector housing assembly is numerous, the structure is complex, it is more difficult to assure respective terminal cavity and terminal slots to be precisely aligned with each other in practical use, there still is a problem that mating between the terminals is not smooth and the terminals still may be bent.

### SUMMARY

Therefore, an object of the present disclosure is to provide an electrical connector assembly in which mating between terminals is smooth and the terminals are not easy to be bent, and a first electrical connector and a second electrical connector, in order to overcome a deficiency as described above in prior art.

Accordingly, a first electrical connector provided by the present disclosure, which is capable of being mated with a second electrical connector, comprises a first insulative housing, a plurality of first conductive terminals and a terminal stabilizer. A mating side of the first insulative housing forms a first mating cavity; the plurality of first conductive terminals are mounted in the first insulative housing, several mating portions of first conductive terminals protrude into the first mating cavity; the terminal stabilizer is moveable in the first insulative housing along a front-rear direction; the terminal stabilizer is provided thereon with a plurality of terminal exposing holes to correspondingly expose the mating portions of the first conductive terminals; a mating side of the terminal stabilizer is provided with at least one pair of elastic latching structures, the pair of elastic latching structures are provided therebetween with an inserting space, each elastic latching structure comprises at least one first latching claw which extends away from a mating direction.

In some embodiments, each elastic latching structure further comprises a main body which has two sides suspended and extends along a transverse direction, the first latching claw obliquely extends from the middle of the main body away from the mating direction.

In some embodiments, an inserting groove is recessed and provided at a side of each main body toward the other main body, the two elastic latching structures of each pair of elastic latching structures are mirror symmetrical; a space between each pair of inserting grooves forms the inserting space, each pair of first latching claws are respectively positioned at an upper side and a lower side of the inserting space.

In some embodiments, each elastic latching structure further comprises two connecting portions which are positioned at the two sides of the main body respectively, one end of the connecting portion is connected to the main body, the other end of the connecting portion is connected to the terminal stabilizer, so that the two sides of the main body are in a suspended state.

In some embodiments, a second latching claw extends out from the terminal stabilizer away from the mating direction, the second latching claw is capable of latching on the first insulative housing, and is used to prevent the terminal stabilizer from being withdrawn from the first insulative housing so that the terminal stabilizer is retained in an initial assembling position.

In some embodiments, the first insulative housing is provided thereon with two first latching portions which are spaced apart from each other by a certain distance, when mating between the first electrical connector and the second electrical connector is completed, the two first latching claws of the terminal stabilizer are capable of correspondingly latching on the two first latching portions, so that the terminal stabilizer and the first conductive terminals are retained in a complete mating position.

In some embodiments, the terminal stabilizer comprises one first terminal stabilizing portion and two second terminal stabilizing portions which are respectively provided at two sides of the first terminal stabilizing portion, each second terminal stabilizing portion is provided with the pair of elastic latching structures.

In some embodiments, an upper side and a lower side of the first terminal stabilizing portion each are provided with a mating claw which extends toward the mating direction,

an upper side and a lower side of each second terminal stabilizing portion each are provided with a second latching claw which extends away from the mating direction.

A second electrical connector provided by the present disclosure comprises a second insulative housing, a plurality of second conductive terminals, an independent secondary locking and a cover. The second insulative housing is formed thereon with a second mating cavity, the second insulative housing is provided with a locking apparatus and an opening; the plurality of second conductive terminals are mounted in the second insulative housing, several mating portions of the second conductive terminals protrude into the second mating cavity; the independent secondary locking can be inserted into the opening to lock the second conductive terminals to the second insulative housing; the cover is mounted in the second mating cavity, and the cover has a plurality of terminal exposing holes to correspondingly expose the second conductive terminals, at least one guiding head protrudes from the cover in a mating direction.

In some embodiments, the locking apparatus is provided thereon with a connector position assurance which is used to prevent locking of the locking apparatus from being wrongly released, wherein the independent secondary locking is provided at a side opposite to the locking apparatus.

In some embodiments, the independent secondary locking comprises latching arms, and a plurality of positioning protrusions and at least one elastic latch which are provided on the latching arms, the elastic latch is used to correspondingly latch to the second insulative housing.

In some embodiments, the independent secondary locking comprises a base portion and three latching arms which extend out from the base portion; the independent secondary locking has two elastic latches, the two elastic latches are respectively connected to outer sides of the two latching arms which are respectively positioned at two sides of the latching arms.

In some embodiments, the guiding head is conical, the guiding head comprises a rear conical portion and a front conical portion which is formed at a front side of the rear conical portion, the front conical portion is connected to the cover.

In some embodiments, the cover comprises a first cover portion and two second cover portions which are respectively provided at two sides of the first cover portion, each second cover portion is provided with one guiding head.

In some embodiments, the second insulative housing is provided with two positioning projections, the elastic latch of the independent secondary locking is capable of cooperating with the two positioning projections respectively so that the independent secondary locking can be retained in a pre-assembling unlocked state or a complete locked state.

A connector assembly provided by the present disclosure comprises the first electrical connector of the present disclosure and the second electrical connector of the present disclosure, when the first electrical connector and the second electrical connector are mated with each other, the guiding head of the second electrical connector is correspondingly inserted into the inserting space between one of the pair of elastic latching structures of the first electrical connector, the first conductive terminals and the second conductive terminals are electrically connected correspondingly.

The present disclosure at least has the following effects: in the present disclosure, the pair of elastic latching structures of the terminal stabilizer of the first electrical connector are formed therebetween with the inserting space, the cover of the second electrical connector is correspondingly provided with the guiding head, when the two connector are mated with each other, the guiding head of the second electrical connector is firstly inserted into the inserting space of the first electrical connector, the guiding head is capable of precisely guiding a movement direction of the first electrical connector to make the first electrical connector aligned with the second electrical connector, so that the first conductive terminals and the second conductive terminals may be guided and smoothly mated with each other, and the terminal stabilizer may prevent the mating portions of the first conductive terminals from being bent or displaced.

### BRIEF DESCRIPTION OF THE DRAWINGS

Other features and effects of the present disclosure will become more apparent from implementing manners with reference to the drawings, in which:

FIG. 1 is a perspective view of a first electrical connector of the present disclosure viewed from an angle with a terminal stabilizer omitted;

FIG. 2 is a perspective view of the first electrical connector of the present disclosure viewed from another angle;

FIG. 3 is a perspective exploded view of the first electrical connector of the present disclosure with first conductive terminals omitted;

FIG. 4 is a perspective view of the terminal stabilizer of the first electrical connector of the present disclosure viewed from an angle;

FIG. 5 is a perspective view of the terminal stabilizer of the first electrical connector of the present disclosure viewed from another angle;

FIG. 6 is a cross-sectional view illustrating that the terminal stabilizer of the first electrical connector of the present disclosure is in an initial assembling position;

FIG. 7 is a cross-sectional view illustrating that the terminal stabilizer of the first electrical connector of the present disclosure is in a complete mating position;

FIG. 8 is a perspective view of a second electrical connector of the present disclosure viewed from an angle with a cover omitted;

FIG. 9 is a perspective view of the second electrical connector of the present disclosure viewed from another angle;

FIG. 10 is a perspective exploded view of the second electrical connector of the present disclosure viewed from an angle;

FIG. 11 is a perspective exploded view of the second electrical connector of the present disclosure viewed from another angle;

FIG. 12 is a cross-sectional view of the second electrical connector of the present disclosure illustrating a state that an independent secondary locking is not mounted in a second insulative housing;

FIG. 13 is a bottom view of the second electrical connector of the present disclosure;

FIG. 14 is a cross-sectional view taken along a line C-C of FIG. 13 illustrating a state that the independent secondary locking is not locked;

FIG. 15 is a cross-sectional view taken along a line F-F of FIG. 13 illustrating a state that the independent secondary locking is not locked;

FIG. 16 is a cross-sectional view taken along a line F-F of FIG. 13 illustrating a state that the independent secondary locking has been locked;

FIG. 17 is a perspective view of a connector assembly of the present disclosure viewed from an angle;

FIG. 18 is a perspective view of the connector assembly of the present disclosure viewed from another angle;

FIG. 19 is a perspective exploded view of the connector assembly of the present disclosure viewed from an angle;

FIG. 20 is a perspective exploded view of the connector assembly of the present disclosure viewed from another angle;

FIG. 21 is a top view of the connector assembly of the present disclosure; and

FIG. 22 is a cross-sectional view taken along a line M-M of FIG. 21.

Reference numerals are presented as follows.

100 first electrical connector

10 first mating cavity

11 first insulative housing

111 guiding portion

112 connector latch

113 second latching portion

115 first latching portion

12 first conductive terminal

13 terminal stabilizer

130 elastic latching structure

131 first latching claw

1310 inserting space

1311 inserting groove

132 main body

133 connecting portion

134 second latching claw

135 mating claw

136 first terminal stabilizing portion

137 second terminal stabilizing portion

200 second electrical connector

20 second mating cavity

21 second insulative housing

210 opening

22 second conductive terminal

23 connector position assurance

24 independent secondary locking

241 latching arm

242 positioning protrusion

243 elastic latch

245 base portion

25 cover

251 first cover portion

252 second cover portion

2511 latching portion

26 guiding head

261 rear conical portion

262 front conical portion

27 locking apparatus

28 sealing member

D1 front-rear direction

D2 left-right direction

D3 up-down direction

### DETAILED DESCRIPTION

Before the present disclosure is described in detail, it is noted that the similar elements are indicated by the same reference numerals in the following described content.

Directions defined in the present disclosure are a front-rear direction D1 (an arrow direction is rear, and a direction opposite to the arrow is front), a left-right direction or transverse direction D2 (an arrow direction is left, and a direction opposite to the arrow is right), and an up-down direction D3 (an arrow direction is up, and a direction opposite to the arrow is down). Any two of the front-rear direction D1, the left-right direction D2 and the up-down direction D3 are perpendicular to each other. Wherein, the front-rear direction D1 is parallel to mating directions between the first electrical connector 100 and the second electrical connector 200, where front corresponds to the mating direction of the first electrical connector 100, and rear corresponds to the mating direction of the second electrical connector 200. Although the terms “up”, “down”, “front”, “rear”, etc. may be used in this specification to describe different exemplary features and elements of the present disclosure, these terms are used only for convenience herein, for example, according to an example orientation as shown in the accompanying drawings. Nothing in the specification should be construed as requiring a specific three-dimensional orientation of the structure to fall within the scope of the present disclosure.

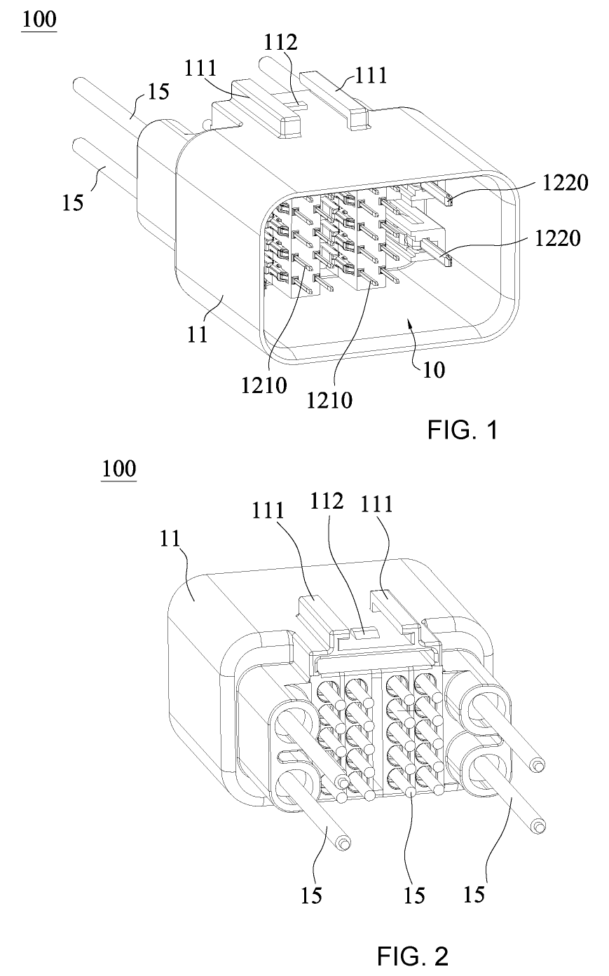

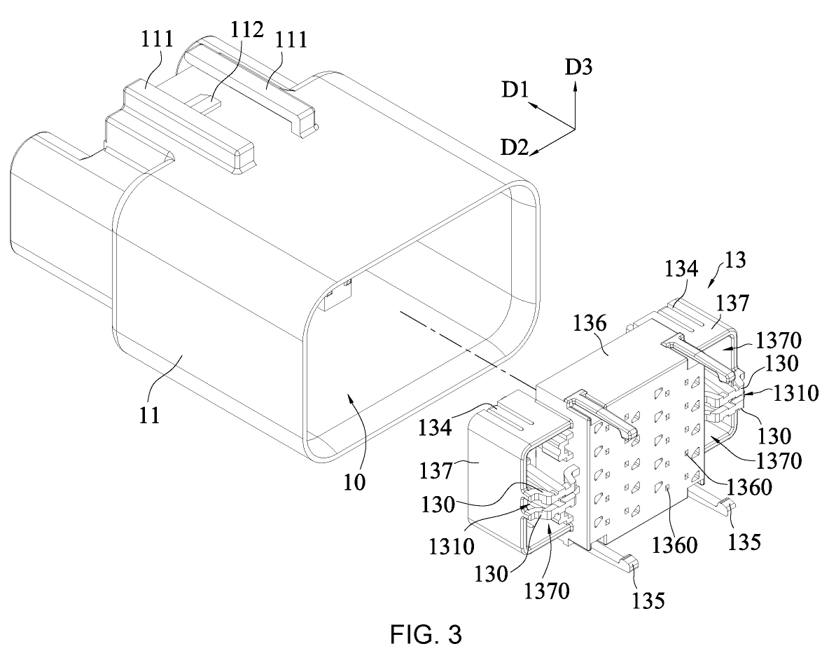

Referring to FIGS. 1 to 5, the first electrical connector 100 of an exemplary embodiment of the present disclosure mainly includes a first insulative housing 11, a plurality of first conductive terminals 12 and a terminal stabilizer 13.

An upper side surface of the first insulative housing 11 is formed with a pair of guiding portions 111 which are parallel to each other and one connector latch 112, the connector latch 112 is positioned between the two guiding portions 111. A mating side of the first insulative housing 11 forms a first mating cavity 10.

The terminal stabilizer 13 is moveable in the first insulative housing 11 along the front-rear direction D1. In the present embodiment, the terminal stabilizer 13 preferably includes one first terminal stabilizing portion 136 and two second terminal stabilizing portions 137, the two second terminal stabilizing portions 137 are symmetrically provided at two sides of the first terminal stabilizing portion 136 along the left-right direction D2.

The first terminal stabilizing portion 136 is provided thereon with multiple terminal exposing holes 1360 which penetrate the first terminal stabilizing portion 136 front and rear, the second terminal stabilizing portions 137 are provided with multiple terminal exposing holes 1370 which penetrate the second terminal stabilizing portions 137 front and rear. In the present embodiment, the terminal exposing hole 1360 of the first terminal stabilizing portion 136 and the terminal exposing hole 1370 of the second terminal stabilizing portion 137 are different in shape and size to be adapted to the different conductive terminals.

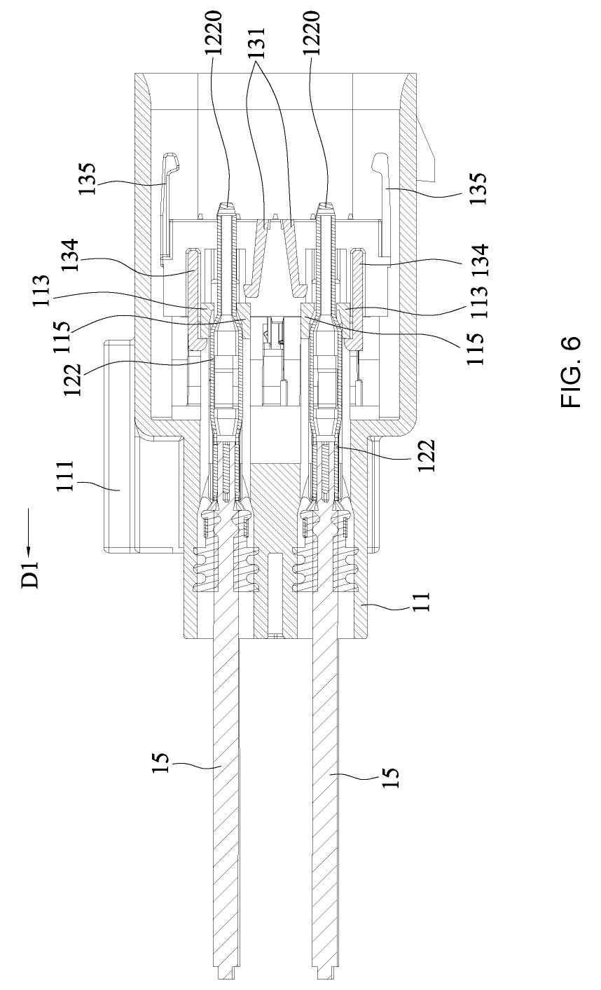

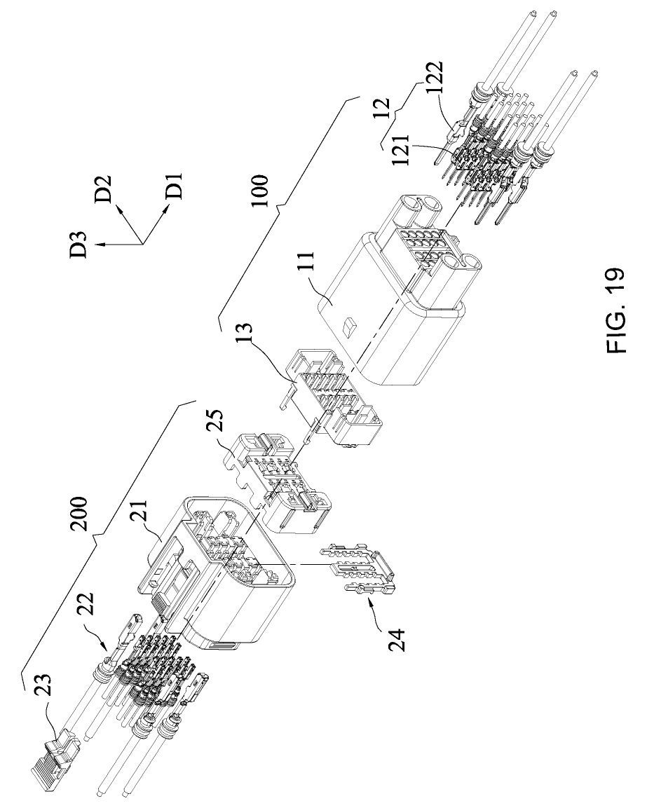

Referring to FIGS. 1 to 3, the plurality of first conductive terminals 12 are mounted in the first insulative housing 11, rear ends of the plurality of conductive terminals 12 are correspondingly connected to corresponding conductive wires 15. In the present embodiment, the plurality of first conductive terminals 12 include thin terminals 121 (see e.g., FIG. 19) and thick terminals 122 (see e.g., FIG. 6, FIG. 19), each thin terminal 121 has a mating portion 1210 in form of needle, each thick terminal 122 also has a mating portion 1220 in form of needle, each mating portion 1210, 1220 respectively passes through the terminal exposing hole 1360, 1370 to be exposed to a mating side of the terminal exposing hole 1360, 1370 and protrude into the first mating cavity 10 of the first insulative housing 11. Wherein, a profile of the terminal exposing hole 1360 and a profile of the mating portion 1210 of the thin terminal 121 basically match each other and are in clearance fit, which may allow the mating portion 1210 to be moved front and rear in the terminal exposing hole 1360 and prevent the mating portion 1210 from being bent. But the terminal exposing hole 1370 and the mating portion 1220 of the thick terminal 122 therebetween have a very large space which may allow the mating portion 1220 to be moved front and rear in the terminal exposing hole 1370.

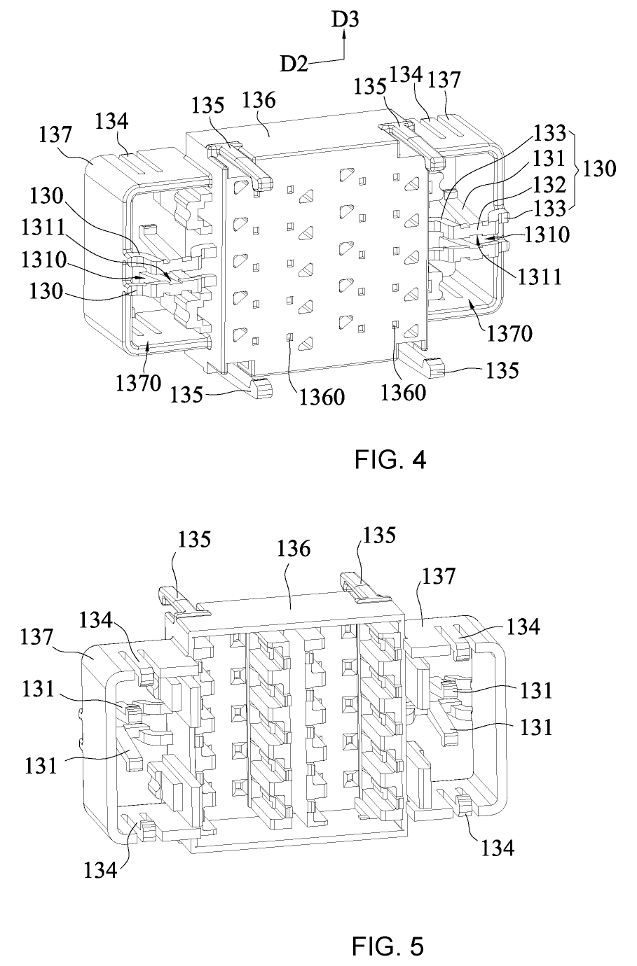

Referring to FIGS. 4 and 5, a mating side of the terminal stabilizer 13 is at least provided with a pair of elastic latching structures 130, the two elastic latching structures 130 of each pair of elastic latching structures 130 are arranged up and down, and are therebetween provided with an inserting space 1310. Wherein, the two elastic latching structures 130 of each pair of elastic latching structures 130 are mirror symmetrical relative to a horizontal plane positioned between the two elastic latching structures 130.

In the illustrated embodiment, the terminal stabilizer 13 has two pairs of elastic latching structures 130 which are respectively provided in the two second terminal stabilizing portions 137.

Each elastic latching structure 130 includes a first latching claw 131, a main body 132 and two connecting portions 133. In other embodiments, the number of the first latching claw 131 is not limited to one, and may also be multiple.

Two sides of the main body 132 are suspended, and the main body 132 extends along the left-right direction D2. In the two connecting portions 133, one end of one connecting portion 133 is connected to one side of the main body 132, the other end of the one connecting portion 133 extends rearwardly, then bends rightwardly, and is connected to the first terminal stabilizing portion 136 (for the elastic latching structures 130 on the left in FIG. 4) or to the second terminal stabilizing portion 137 (for the elastic latching structures 130 on the right in FIG. 4). One end of the other connecting portion 133 is connected to the other side of the main body 132, the other end of the other connecting portion 133 extends rearwardly, then bends leftwardly, and is connected to the second terminal stabilizing portion 137 (for the elastic latching structures 130 on the left in FIG. 4) or to the first terminal stabilizing portion 136 (for the elastic latching structures 130 on the right in FIG. 4). The two sides of the main body 132 are in a suspended state, which facilitates splaying or elastic restoring of the main body 132 during mating.

The first latching claw 131 obliquely extends from the middle of the main body 132 away from the mating direction. The first latching claw 131 of one elastic latching structure 130 which is positioned up in each pair of elastic latching structures 130 obliquely extends upwardly, and the first latching claw 131 of one elastic latching structure 130 which is positioned down in each pair of elastic latching structures 130 obliquely extends downwardly. An inserting groove 1311 is recessed and provided at a side of each main body 132 toward the other main body 132, the two inserting grooves 1311 of the two main bodies 132 are provided to face each other, a space between each pair of inserting grooves 1311 forms the inserting space 1310, each pair of first latching claws 131 are respectively positioned at an upper side and a lower side of the inserting space 1310, so that when the inserting space 1310 is expanded or contracted, the first latching claws 131 which are adjacent to the inserting space 1310 will move correspondingly.

When the first electrical connector 100 and the second electrical connector 200 are correspondingly mated with each other, a distance between the pair of main bodies 132 of the pair of elastic latching structures 130 in the up-down direction D3 may become large and then elastically restore to become small. That is, as an entrance of the inserting space 1310 is expanded and then elastically contracted, a distance between rear ends of the pair of first latching claws 131 of the pair of elastic latching structures 130 becomes smaller and then elastically restores to become larger.

An upper side and a lower side of each second terminal stabilizing portion 137 each are provided with a second latching claw 134 which extends rearwardly, the second latching claw 134 can latch on the first insulative housing 11. An upper side and a lower side of the first terminal stabilizing portion 136 are each provided with a mating claw 135 which extends forwardly and is used to be connected with the second electrical connector 200.

Referring to FIGS. 1, 3 and 6, when the first electrical connector 100 of the present disclosure is assembled, the multiple thin terminals 121 and the multiple thick terminals 122 are mounted into the first insulative housing 11, and then the terminal stabilizer 13 is mounted into the first insulative housing 11 along a direction which is from front to rear; the mating portions 1210 of the multiple thin terminals 121 respectively pass through the terminal exposing holes 1360 of the first terminal stabilizing portion 136 and protrude into the first mating cavity 10. At the same time, the mating portions 1220 of the multiple thick terminals 122 respectively pass through the terminal exposing holes 1370 of the two second terminal stabilizing portions 137 and protrude into the first mating cavity 10. As a result, assembling of the first electrical connector 100 is completed.

Referring to FIG. 6, the terminal stabilizer 13 is moveable relative to the first insulative housing 11 along the front-rear direction D1. In order to prevent the terminal stabilizer 13 from being withdrawn from the first insulative housing 11, the first insulative housing 11 is provided therein with second latching portions 113. The second latching claws 134 of the terminal stabilizer 13 may latch on the second latching portions 113, so that the terminal stabilizer 13 is prevented from being withdrawn from the first insulative housing 11, and the terminal stabilizer 13 is retained in an initial assembling position.

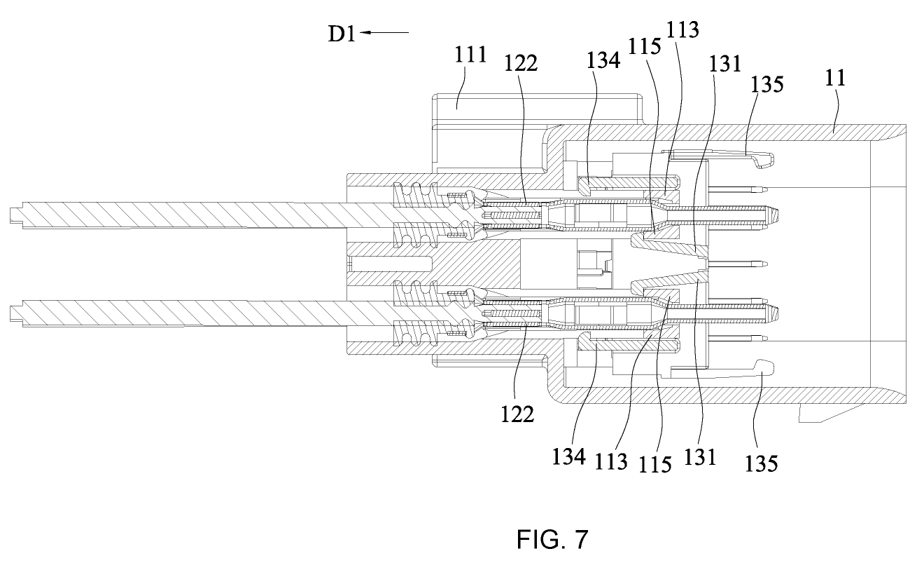

Referring to FIG. 7, the first insulative housing 11 is provided therein with two first latching portions 115 which are spaced apart from each other by a certain distance and are provided away from each other, when mating between the first electrical connector 100 of the present disclosure and another connector, for example the second connector 200, is completed. The two first latching claws 131 of the terminal stabilizer 13 are capable of correspondingly latching on the two first latching portions 115, so that the terminal stabilizer 13 and the plurality of first conductive terminals 12 are retained in a complete mating position.

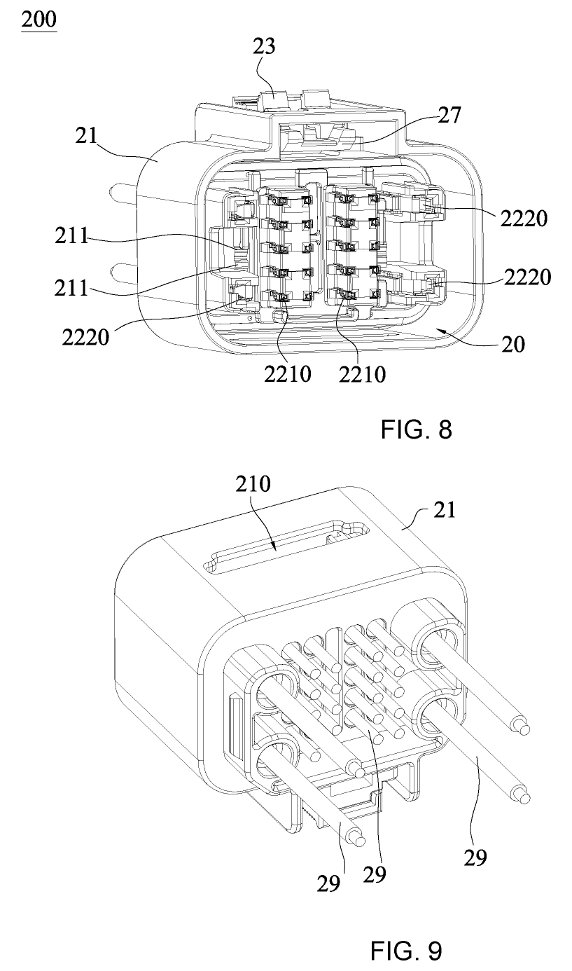

Referring to FIGS. 8 to 11, a second electrical connector 200 of an exemplary embodiment of the present disclosure includes a second insulative housing 21, a plurality of second conductive terminals 22, an independent secondary locking 24, a cover 25, and a sealing member 28.

An upper side of the second insulative housing 21 is provided with a locking apparatus 27 and a connector position assurance 23 which is used to prevent locking of the locking apparatus 27 from being wrongly released. A lower side of the second insulative housing 21 is provided with an opening 210, and a rear side of the second insulative housing 21 forms a second mating cavity 20.

The plurality of second conductive terminals 22 are mounted in the second insulative housing 21. Tips of the plurality of conductive terminals 22 are correspondingly connected to corresponding conductive wires 29. In the illustrated embodiment, the plurality of second conductive terminals 22 include thin terminals 221 and thick terminals 222. Each thin terminal 221 has a mating portion 2210, each thick terminal 222 has a mating portion 2220.

The cover 25 is mounted in the second mating cavity 20 of the second insulative housing 21 and has a plurality of terminal exposing holes 250 to correspondingly expose the mating portions of the plurality of second conductive terminals 22. In the illustrated embodiment, the cover 25 includes one first cover portion 251 and two second cover portions 252. The two second cover portions 252 are symmetrically provided at two sides of the first cover portion 251 along the left-right direction D2.

The first cover portion 251 is provided thereon with terminal exposing holes 2510, the second cover portions 252 are provided thereon with terminal exposing holes 2520. In the present embodiment, the terminal exposing hole 2520 of the second cover portion 252 and the terminal exposing hole 2510 of the first cover portion 251 are different in shape, so as to expose the mating portions of the different conductive terminals, for example, the mating portion 2210 of the thin terminal 221 and the mating portion 2220 of the thick terminal 222. In other embodiments, the terminal exposing hole 2520 of the second cover portion 252 and the terminal exposing hole 2510 of the first cover portion 251 also may be the same in shape.

An upper side and a lower side of the first cover portion 251 are each formed with two latching portions 2511, which allow the mating claws 135 of the first connector 100 to latch therewith.

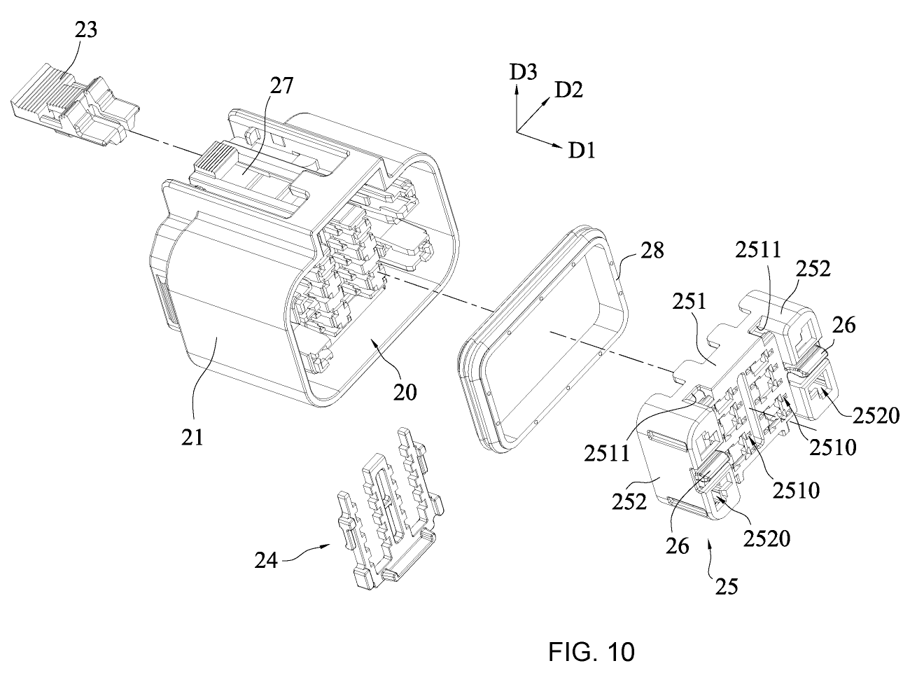

At least one conical guiding head 26 protrudes from the cover 25 rearwardly (that is, toward the mating direction). Referring to FIG. 10, the illustrated embodiment is provided with two conical guiding heads 26 which are respectively provided at mating sides of the two second cover portions 252.

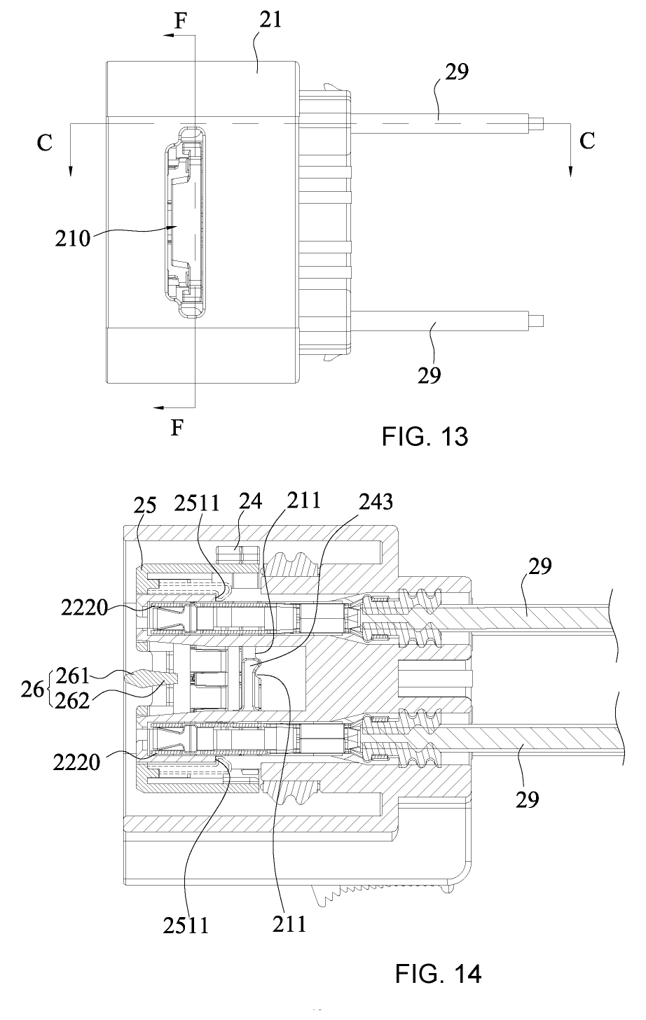

Referring to FIGS. 13 and 14, the guiding head 26 may include a rear conical portion 261 and a front conical portion 262. The rear conical portion 261 protrudes from a mating portion surface of the cover 25 toward the mating direction, the front conical portion 262 is formed at a front side of the rear conical portion 261, and a front side of the front conical portion 262 is connected to the cover 25. A dimension of the rear conical portion 261 in the up-down direction D3 gradually becomes large along a direction which is from rear to front. A dimension of the front conical portion 262 in the up-down direction D3 gradually becomes small along the direction which is from rear to front.

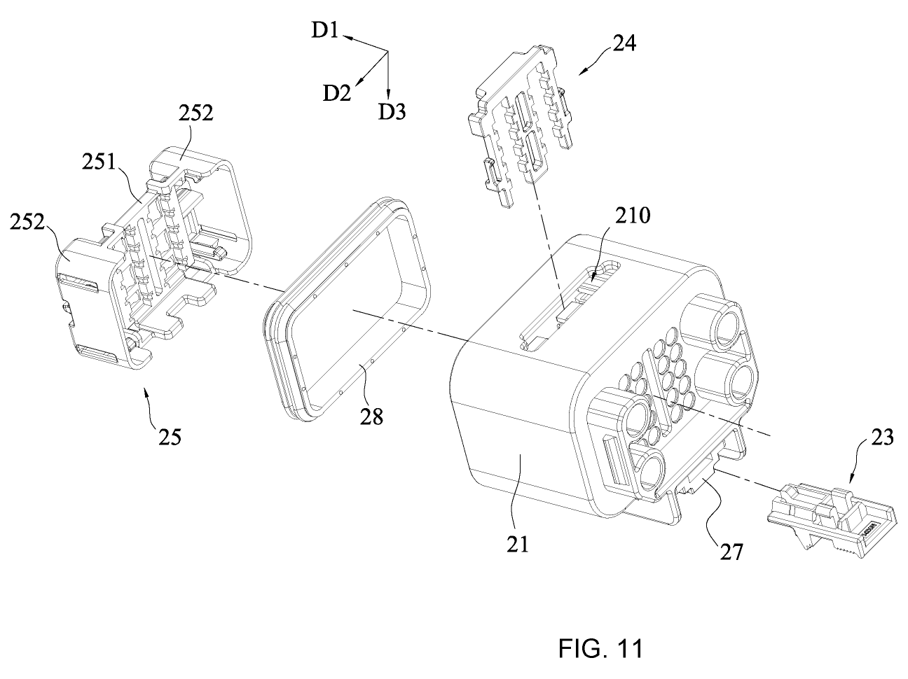

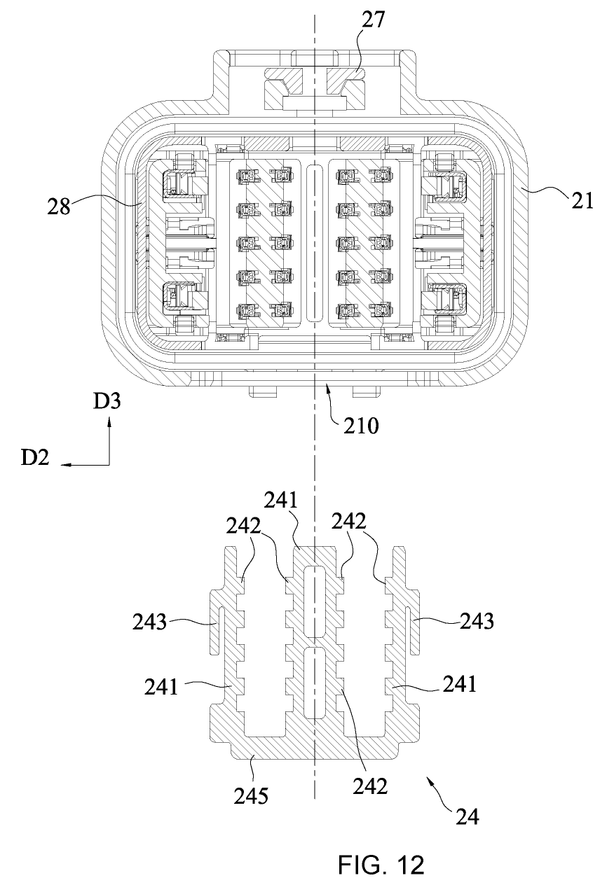

Referring to FIGS. 11 and 12, the independent secondary locking 24 can be correspondingly inserted into the opening 210 of the second insulative housing 21. The independent secondary locking 24 includes a base portion 245 and three latching arms 241 which extend out from the base portion 245 and are parallel to each other and two elastic latches 243. The base portion 245 extends along the left-right direction D2. Lower ends of the three latching arms 241 are connected to the base portion 245, and the three latching arms 241 upwardly extend out from the base portion 245. The three latching arms 241 are each provided with positioning protrusions 242. Two positioning protrusions 242 are on opposite sides of the latching arm 241 which is positioned in the middle of the three latching arms 241. The two latching arms 241, which are positioned on opposite sides of the latching arm 241 in the middle of the three latching arms 241, each have a positioning protrusion 242 on a side toward the latching arm 241 which is positioned in the middle of the three latching arms 241. Sides of the two latching arms 241 that are positioned at the two sides of the three latching arms 241, which are farthest away from the latching arm 241 which is positioned in the middle of the three latching arms 241, are connected with two elastic latches 243, respectively. One end of the elastic latch 243 is connected to one of the latching arms 241, and an elastic part of the elastic latch 243 is parallel to the latching arm 241, is spaced apart from the latching arm 241 by a gap, and extends along the up-down direction D3.

Referring to FIGS. 8 and 14, the second insulative housing 21 is provided therein with two positioning projections 211 which protrude toward the mating direction.

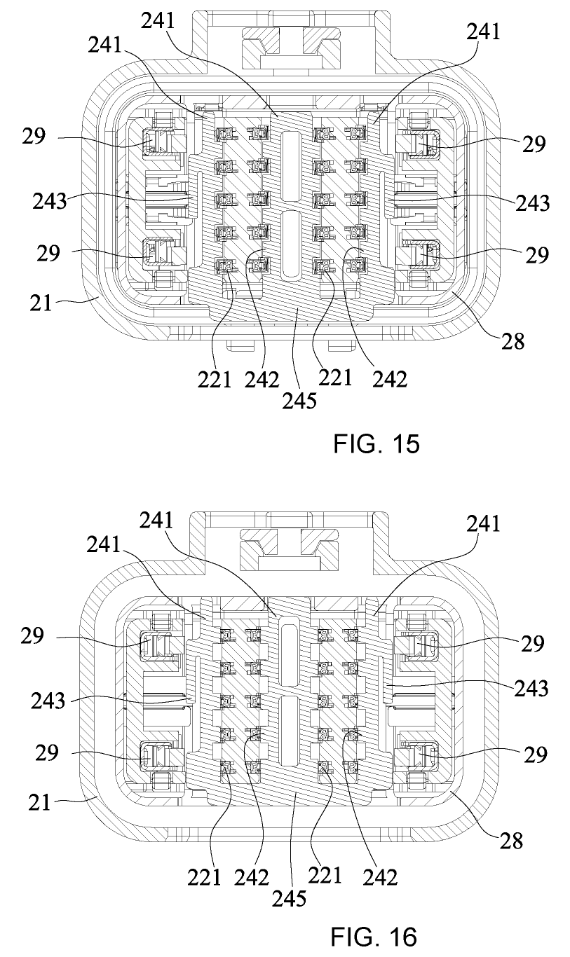

Referring to FIG. 15, when the independent secondary locking 24 is upwardly inserted into the second insulative housing 21 from the opening 210 at the lower side of the second insulative housing 21, the elastic latch 243 of the independent secondary locking 24 cooperates with and is positioned by the first one positioning projection 211, the independent secondary locking 24 is in a pre-assembling unlocked state. At this time, the plurality of second conductive terminals 22 of the second connector 200, for example, the thin terminals 221 and the thick terminals 222, have not been locked to the second insulative housing 21.

Referring to FIG. 16, when the independent secondary locking 24 is continuously moved upwardly, when the elastic latch 243 of the independent secondary locking 24 cooperates with and is positioned by the second one positioning projection 211, the independent secondary locking 24 is in a complete locked state. At this time, the plurality of second conductive terminals 22 of the second connector 200, for example, the thin terminals 221 and the thick terminals 222, are locked in a fixing position.

Referring to FIG. 10, when the second electrical connector 200 is assembled, the plurality of second conductive terminals 22 may be mounted in the second insulative housing 21. The independent secondary locking 24 may then be inserted into the second insulative housing 21 from the opening 210 at the lower side of the second insulative housing 21 to reach a pre-assembling unlocked state. Then, the cover 25 is mounted in the second insulative housing 21. Then, the independent secondary locking 24 is pushed upwards to reach the complete locked state, and assembling of the second electrical connector 200 is completed.

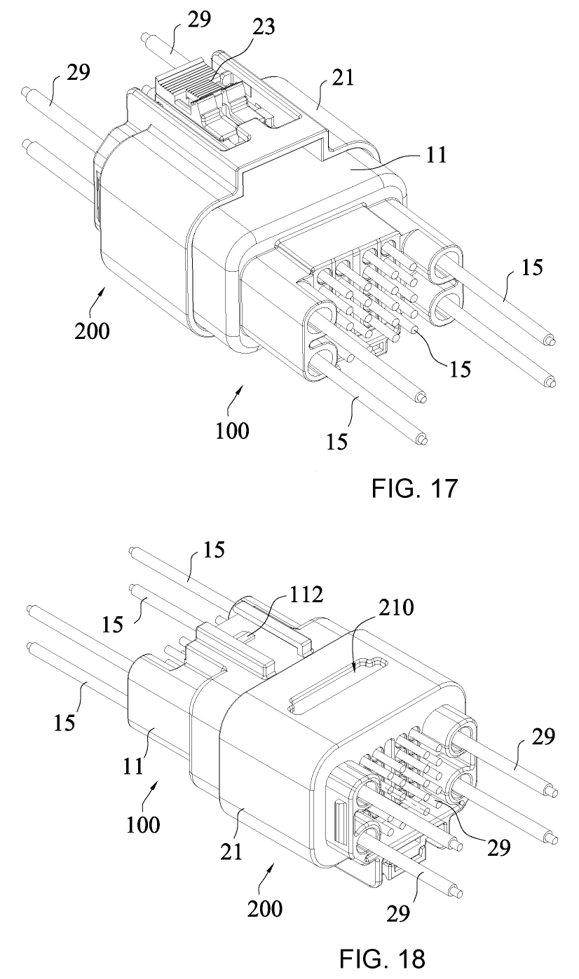

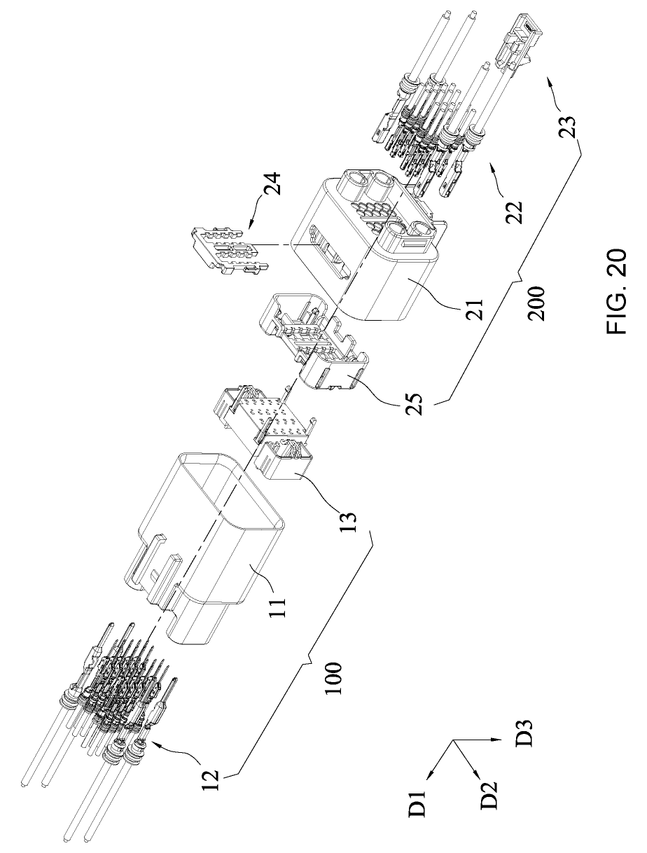

Referring to FIGS. 17 to 20, an exemplary embodiment of a connector assembly of the present disclosure includes the first electrical connector 100 and the second electrical connector 200 which are mated with each other.

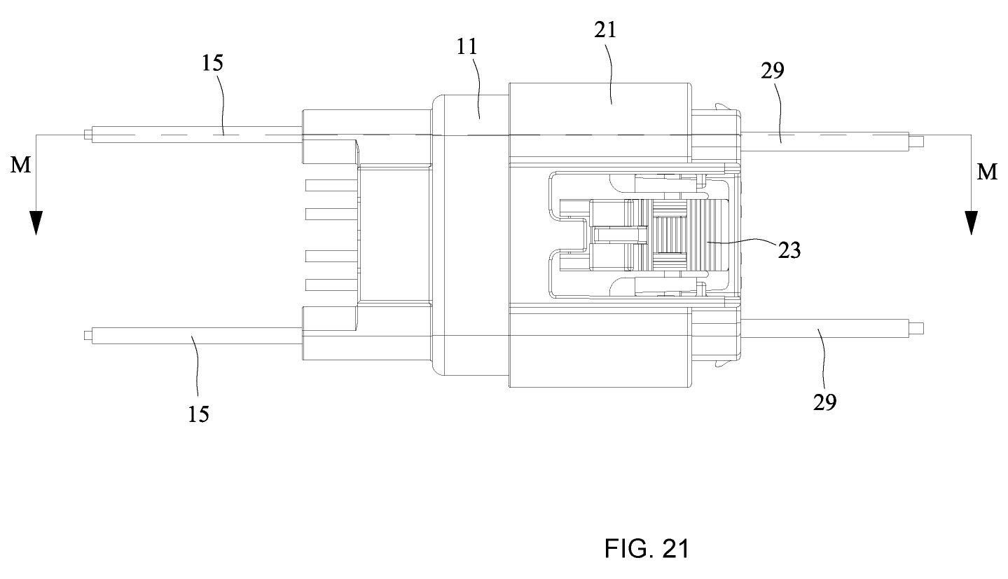

Referring to FIGS. 19 to 22, when the first electrical connector 100 and the second electrical connector 200 are mated with each other, the first electrical connector 100 moves along the front-rear direction D1 to approach the second electrical connector 200. The guiding head 26 of the cover 25 of the second electrical connector 200 contacts the elastic latching structures 130 of the terminal stabilizer 13 of the first electrical connector 100. Specifically, the guiding head 26 will be correspondingly inserted into the inserting space 1310 between the pair of elastic latching structures 130 from the inserting grooves 1311 of the main bodies 132. Cooperation between the guiding head 26 and the elastic latching structures 130 functions as directional guiding for movement of the first electrical connector 100, so that the first electrical connector 100 moves precisely along the front-rear direction D1 without skew. Thus, the first conductive terminals 121, 122 can be accurately inserted into the terminal exposing holes 2510, 2520 of the second electrical connector 200 and mated with the second conductive terminals 221, 222, which prevents the first conductive terminals 121, 122 from being bent.

Next, the terminal stabilizer 13 of the first electrical connector 100 begins to rearwardly move relative to the first electrical connector 100, and the guiding head 26 of the second electrical connector 200 is continuously inserted into the inserting space 1310 until the guiding head 26 of the second electrical connector 200 is inserted in place. That is, until mating between the first electrical connector 100 and the second electrical connector 200 is completed. At this time, the mating claws 135 of the terminal stabilizer 13 of the first electrical connector 100 will latch on the latching portions 2511 of the cover 25 of the second electrical connector 200 (see FIG. 14), so that the two electrical connectors 100, 200 are not easily separated from each other.

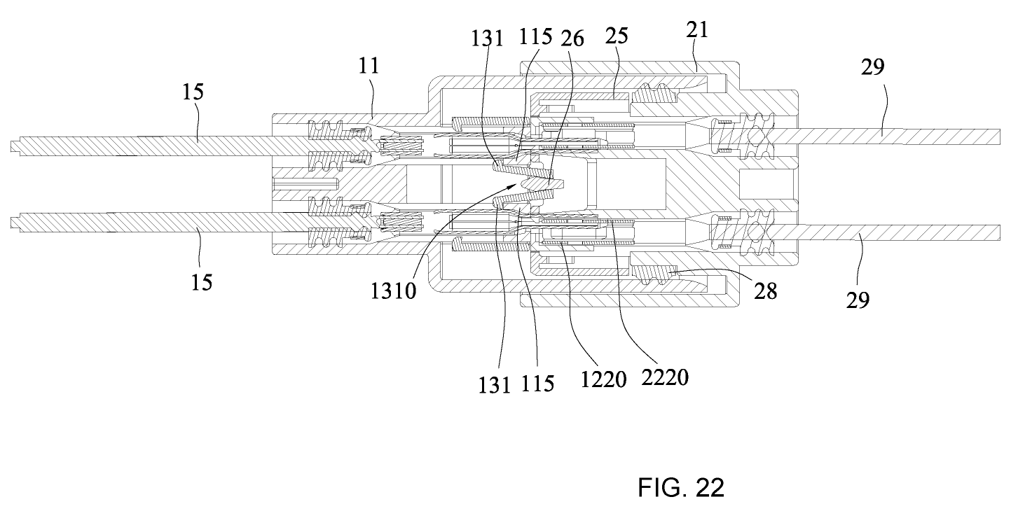

Referring to FIG. 22 and in conjunction with referring to FIG. 6, when the conical the guiding head 26 of the second electrical connector 200 begins to be inserted into the inserting space 1310 of the first electrical connector 100, until the guiding head 26 is inserted in place, the distance between the mating portions of the pair of first latching claws 131 of the pair of elastic latching structures 130 which form the inserting space 1310 firstly gradually become large, so that the tips of the first latching claws 131 away from the mating side close toward each other. The tips of the first latching claw 131 can then enter into a passageway between the two first latching portions 115 of the first electrical connector 100 and continuously moving rearwardly. Then, the tips of the two first latching claws 131 respectively latch on two inner sides of the two first latching portions 115 (as shown in FIGS. 22 and 7). That is to say, in the connector assembly according to various embodiments, when mating between the first electrical connector 100 and the second electrical connector 200 is completed, the first latching claws 131 of the terminal stabilizer 13 of the first electrical connector 100 latch on the first insulative housing 11. This locks relative positions between the terminal stabilizer 13 and the first insulative housing 11, so that the first conductive terminals 12 are retained in the complete mating position, which ensures reliability of electrical connection between the first conductive terminals 12 and the second conductive terminals 22.

The above description of the exemplary embodiments of the present disclosure is only explanatory, and it is not intended to limit the implementing scope of the present disclosure. Equivalent changes and modifications made according to the claims and the contents of the specification of the present disclosure are within the scope of the present disclosure.

What is claimed is:

1. A first electrical connector, which is capable of being mated with a second electrical connector, comprising:
an insulative housing, a mating side of the insulative housing forming a mating cavity;
a plurality of conductive terminals mounted in the insulative housing, mating portions of the conductive terminals protruding into the mating cavity;
a terminal stabilizer, which is moveable in the insulative housing along a front-rear direction, wherein
the terminal stabilizer comprises a plurality of terminal exposing holes to correspondingly expose the mating portions of the conductive terminals;
a mating side of the terminal stabilizer is provided with a pair of elastic latching structures, the pair of elastic latching structures being provided with an inserting space therebetween; and
each elastic latching structure of the pair of elastic latching structures comprises a first latching claw which extends away from a mating direction.

2. The first electrical connector according to claim 1, wherein
each elastic latching structure of the pair of elastic latching structures further comprises a main body which has two sides suspended and extends along a transverse direction, and the first latching claw obliquely extends from the middle of the main body away from the mating direction.

3. The first electrical connector according to claim 2, wherein
for each elastic latching structure of the pair of elastic latching structures, a recessed inserting groove is provided at a side of the main body facing the main body of another elastic latching structure of the pair of elastic latching structures;
the elastic latching structures of the pair of elastic latching structures are mirror symmetrical;
a space between the inserting grooves of the elastic latching structures of the pair of elastic latching structures forms the inserting space; and
the first latching claws of the elastic latching structures of the pair of elastic latching structures are respectively positioned at an upper side and a lower side of the inserting space.

4. The first electrical connector according to claim 3, wherein
each elastic latching structure of the pair of elastic latching structures further comprises two connecting portions which are positioned at the two sides of the main body respectively, one end of each of the two connecting portions is connected to the main body and the other end of each of the two connecting portions is connected to the terminal stabilizer, so that the two sides of the main body are in a suspended state.

5. The first electrical connector according to claim 1, wherein
a second latching claw extends out from the terminal stabilizer away from the mating direction;
the second latching claw is capable of latching on the insulative housing, and is used to prevent the terminal stabilizer from being withdrawn from the insulative housing so that the terminal stabilizer is retained in an initial assembling position.

6. The first electrical connector according to claim 1, wherein
the insulative housing comprises two first latching portions which are spaced apart from each other,
when mating between the first electrical connector and the second electrical connector is completed, the first latching claws of each elastic latching structure of the pair of elastic latching structures of the terminal stabilizer correspondingly latch on the two first latching portions, so that the terminal stabilizer and the conductive terminals are retained in a complete mating position.

7. The first electrical connector according to claim 1, wherein
the terminal stabilizer comprises one first terminal stabilizing portion and two second terminal stabilizing portions which are respectively provided at two sides of the first terminal stabilizing portion,
each second terminal stabilizing portion is provided with the pair of elastic latching structures.

8. The first electrical connector according to claim 7, wherein
an upper side and a lower side of the first terminal stabilizing portion are each provided with a mating claw which extends toward the mating direction,
an upper side and a lower side of each of the two second terminal stabilizing portions are each provided with a second latching claw which extends away from the mating direction.

9. An electrical connector, comprising:
an insulative housing, the insulative housing comprising a mating cavity, a locking apparatus, and an opening;
a plurality of conductive terminals mounted in the insulative housing, mating portions of the conductive terminals protruding into the mating cavity;
an independent secondary locking to be inserted into the opening to lock the conductive terminals to the insulative housing; and
a cover, the cover being mounted in the mating cavity, and the cover having a plurality of terminal exposing holes to correspondingly expose the conductive terminals, at least one guiding head protruding from the cover in a mating direction.

10. The second electrical connector according to claim 9, wherein
the locking apparatus is provided thereon with a connector position assurance which is used to prevent locking of the locking apparatus from being wrongly released, wherein the independent secondary locking is provided at a side opposite to the locking apparatus.

11. The second electrical connector according to claim 10, wherein
the independent secondary locking comprises latching arms, and a plurality of positioning protrusions and at least one elastic latch are provided on the latching arms, the elastic latch is used to correspondingly latch to the insulative housing.

12. The second electrical connector according to claim 11, wherein
the independent secondary locking comprises a base portion and three latching arms which extend out from the base portion;
the independent secondary locking has two elastic latches, the two elastic latches are respectively connected to outer sides of two of the three latching arms which are respectively positioned at two sides of the three latching arms.

13. The second electrical connector according to claim 9, wherein
the at least one guiding head is conical;
the at least one guiding head comprises a rear conical portion and a front conical portion which is formed at a front side of the rear conical portion, and the front conical portion is connected to the cover.

14. The second electrical connector according to claim 9, wherein
the cover comprises a first cover portion and two second cover portions which are respectively provided at two sides of the first cover portion, each of the two second cover portions is provided with one guiding head.

15. The second electrical connector according to claim 11, wherein
the insulative housing is provided with two positioning projections,
the at least one elastic latch of the independent secondary locking is capable of cooperating with the two positioning projections respectively so that the independent secondary locking can be retained in a pre-assembling unlocked state or a complete locked state.

16. A connector assembly, comprising:
a first electrical connector comprising:
a first insulative housing, a mating side of the first insulative housing forming a first mating cavity;
a plurality of first conductive terminals mounted in the first insulative housing, mating portions of the first conductive terminals protruding into the first mating cavity;
a terminal stabilizer, which is moveable in the first insulative housing along a front-rear direction, wherein
the terminal stabilizer comprises a plurality of terminal exposing holes to correspondingly expose the mating portions of the first conductive terminals;
a mating side of the terminal stabilizer is provided with at least one pair of elastic latching structures, the pair of elastic latching structures being provided with an inserting space therebetween; and
each elastic latching structure of the at least one pair of elastic latching structures comprising at least one first latching claw which extends away from a mating direction; and
a second electrical connector comprising:
a second insulative housing, the second insulative housing being formed thereon with a second mating cavity, a locking apparatus, and an opening;
a plurality of second conductive terminals, which are mounted in the second insulative housing, several mating portions of the second conductive terminals protruding into the second mating cavity;
an independent secondary locking to be inserted into the opening to lock the second conductive terminals to the second insulative housing; and
a cover, the cover being mounted in the second mating cavity, and the cover having a plurality of terminal exposing holes to correspondingly expose the second conductive terminals, at least one guiding head protruding from the cover in a mating direction, wherein
when the first electrical connector and the second electrical connector are mated with each other, the at least one guiding head of the second electrical connector is correspondingly inserted into the inserting space of the first electrical connector, the first conductive terminals and the second conductive terminals being electrically connected correspondingly.
